(19) United States
(12) Patent Application Publication
(10) Pub. No.: US 2009/0036809 A1
(43) Pub. Date: Feb. 5, 2009

(54) Massage machine

(75) Inventors: Fumihiro Nishio, Hikone (JP); Junji Nakamura, Hikone (JP); Takayoshi Tanizawa, Higashiomi (JP); Daisuke Tsukada, Hikone (JP); Satoshi Kajiyama, Hikone (JP); Shohei Taniguchi, Osaka (JP)

Correspondence Address: BACON & THOMAS, PLLC, 625 SLATERS LANE, FOURTH FLOOR, ALEXANDRIA, VA, 22314-1176, US

(73) Assignee: Matsushita Electric Works, Ltd., Osaka (JP)

(21) Appl. No.: 12/219,407

(22) Filed: Jul. 22, 2008

(30) Foreign Application Priority Data
Jul. 31, 2007 (JP) 2007-199850

(51) Int. Cl. A61H 7/00

(52) U.S. Cl. 601/134; 601/148; 601/150

(57) ABSTRACT

A massage machine includes a backrest having a support surface for sustaining a back of a user, the support surface having an opening, a massage member for making contact with the back of the user through the opening of the support surface to perform a massage and a drive unit for causing the massage member to perform the massage. In the massage machine, a first intensity adjustment unit is arranged for changing the position of the massage member to adjust the massage intensity of the massage member and a second intensity adjustment unit is arranged for changing the position of the support surface to adjust the massage intensity of the massage member. A control circuit controls the operation of the drive unit, the first intensity adjustment unit and the second intensity adjustment unit.

### FIELD OF THE INVENTION

The present invention relates to a massage machine and, more specifically, to a massage machine having a function of adjusting the massage intensity thereof.

### BACKGROUND OF THE INVENTION

There has been provided a massage machine having a massage mechanism built in a backrest of a chair for massaging a back of a user. Depending on the method of adjusting the massage intensity, the massage machines are classified into a type (see, e.g., Japanese Patent Laid-open Publication No. 2006-34635) in which the massage intensity is adjusted by changing the protrusion amount of a massage member, provided to a massage mechanism, toward a user's body and a type (see, e.g., Japanese Patent Laid-open Publication No. 2004-181153) in which the massage intensity is adjusted by changing a relative space between a massage mechanism and a support surface for supporting the back of the user, e.g., a front surface of a backrest.

In order to meet individual preference for the massage intensity, it is desirable to set the extent of intensity adjustment as broad as possible. In case of the former type of massage machine, it is structurally difficult to increase the extent of intensity adjustment without increasing in size of the massage mechanism. Particularly, in case of the massage machine disclosed in Japanese Patent Laid-open Publication No. 2006-34635, the massage intensity is adjusted by rotating an arm and changing the angle thereof. Therefore, the length of the arm needs to be made longer in order to increase the extent of intensity adjustment. This makes it necessary to increase the vertical extent of position adjustment of the arm, which in turn results in an increase in the size of the massage mechanism.

In case of the latter type of massage machine, the massage mechanism requires no arrangement for adjusting the massage intensity. However, the support surface needs to be moved as a whole, which reduces responsiveness of the intensity adjustment. Therefore, it is impossible to immediately weaken the massage intensity, e.g., when the massage is as intensive as a user feels painful.

### SUMMARY OF THE INVENTION

In view of the above, the present invention provides a massage machine capable of enjoying an increased extent of intensity adjustment and also capable of adjusting massage intensity with enhanced responsiveness.

In accordance with the present invention, there is provided a massage machine including: a backrest having a support surface for sustaining a back of a user, the support surface having an opening; a massage member for making contact with the back of the user through the opening of the support surface to perform a massage; a drive unit for causing the massage member to perform the massage; a first intensity adjustment unit for changing the position of the massage member to adjust the massage intensity of the massage member; a second intensity adjustment unit for changing the position of the support surface to adjust the massage intensity of the massage member; and a control circuit for controlling the operation of the drive unit, the first intensity adjustment unit and the second intensity adjustment unit.

With such configuration, it is possible to perform the intensity adjustment with the second intensity adjustment unit that moves the support surface, as well as the first intensity adjustment unit.

It is preferred that the control circuit allows the second intensity adjustment unit to make rough intensity adjustment and allows the first intensity adjustment unit to make fine intensity adjustment.

With such configuration, suitable intensity adjustment can be assured at all times by performing the rough intensity adjustment through the movement of the support surface with no application of a load to a user and by allowing the first intensity adjustment unit with enhanced responsiveness to perform the fine intensity adjustment.

Furthermore, the control circuit may cause the massage member to start the massage in a predetermined intensity position set by the second intensity adjustment unit.

With such configuration, it is possible to start the massage in a preset recommended intensity position, thereby allowing the massage member to perform a massage with a recommended intensity.

The predetermined intensity position may be a position set by an input manipulation of a user. This makes it possible to meet the user's preference.

The massage machine may further include a pressure sensor for detecting a contact pressure between the massage member and the back of the user, and wherein the control circuit recognizes the shape of the back of the user from the change in output of the pressure sensor at the time when the massage member is moved along the back of the user and initially sets the massage intensity based on the results of recognition.

With such configuration, it is possible to automatically adjust the massage intensity in conformity with the physique and shape of the user, thereby eliminating the need for the user to conduct any manipulation for intensity adjustment.

The control circuit may adjust the massage intensity according to the change in output of the pressure sensor even after the massage intensity has been initially set. This makes it possible to perform a massage with suitable massage intensity in keeping with the change in user's posture during the massage.

The second intensity adjustment unit may include an airbag arranged on the support surface for expansion and contraction. This allows the second intensity adjustment unit to perform the intensity adjustment without giving a sense of incongruity to the user. Furthermore, the airbag is capable of lifting the back of the user even when a person with a different physique sits on the massage machine.

The airbag may include a plurality of airbags arranged in a vertical direction along the back of user. In this case, it becomes possible to massage the shoulder and the waist with different massage intensity, thereby realizing various kinds of massages.

In accordance with the present invention, the massage machine includes the second intensity adjustment unit in addition to the first intensity adjustment unit. Therefore, the extent of intensity adjustment can be broadened by operating the first and second intensity adjustment units in combination. Responsiveness does not matter because the intensity adjustment operation requiring enhanced responsiveness can be performed by the corresponding intensity adjustment unit (the first intensity adjustment unit). Furthermore, there is no need for the first intensity adjustment unit to have an increased intensity adjustment extent. This eliminates a possibility of scale-up of the massage machine.

### BRIEF DESCRIPTION OF THE DRAWINGS

The object and features of the present invention will become apparent from the following description of embodiments given in conjunction with the accompanying drawings, in which:

FIG. 1 is a perspective view showing a massage machine in accordance with an embodiment of the present invention, wherein a trim cover is removed for clarity;

FIG. 2 is a block diagram showing a circuit employed in the massage machine;

FIG. 3 is a side view of the massage machine illustrating intensity adjustment extents S1 and S2;

FIG. 4 is a perspective view showing a massage machine in accordance with another embodiment of the present invention;

FIG. 5 is a time chart illustrating one example of the operation of the massage machine;

FIG. 6 is a time chart illustrating another example of the operation of the massage machine;

FIG. 7 is a view explaining a feedback control operation that makes use of the pressure detected by a pressure sensor of the massage machine;

FIG. 8 is a view explaining another feedback control operation that makes use of the pressure detected by a pressure sensor of the massage machine;

FIG. 9 is a flowchart illustrating the operation of the massage machine; and

FIG. 10 is a perspective view showing a massage machine in accordance with a further embodiment of the present invention.

### DETAILED DESCRIPTION OF THE PREFERRED EMBODIMENTS

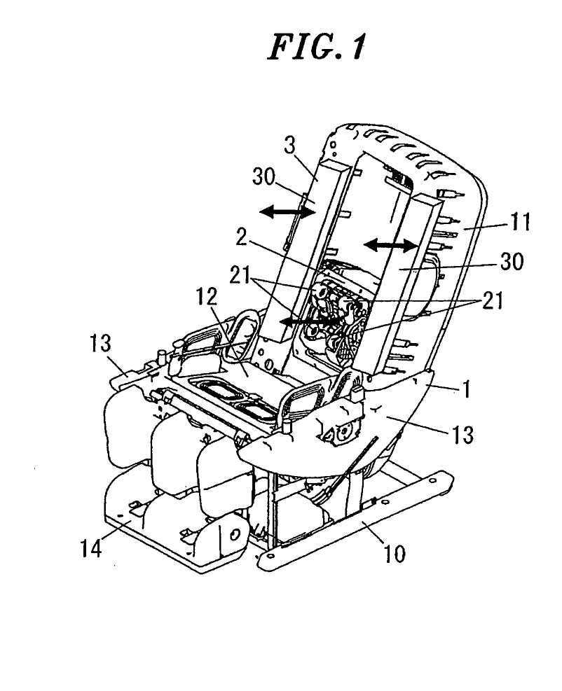

Hereinafter, the present invention will be described with respect to embodiments illustrated in FIGS. 1 to 10, which form a part hereof.

FIG. 1 is a perspective view showing a chair-type massage machine 1 in accordance with an embodiment of the present invention, wherein a trim cover is removed for clarity. As shown, the chair-type massage machine 1 includes a frame 10, a backrest 11, a seat part 12, an armrest 13 and a footrest 14. A massage mechanism 2 is built in the backrest 11.

The massage mechanism 2 is provided with four massage members 21 in total and a drive unit for moving the massage members 21 to massage a back of a user reclining against the backrest 11. The massage mechanism 2 is vertically movably arranged in a frame (not shown) of the backrest 11 and, therefore, is capable of changing the vertical position of the massage members 21.

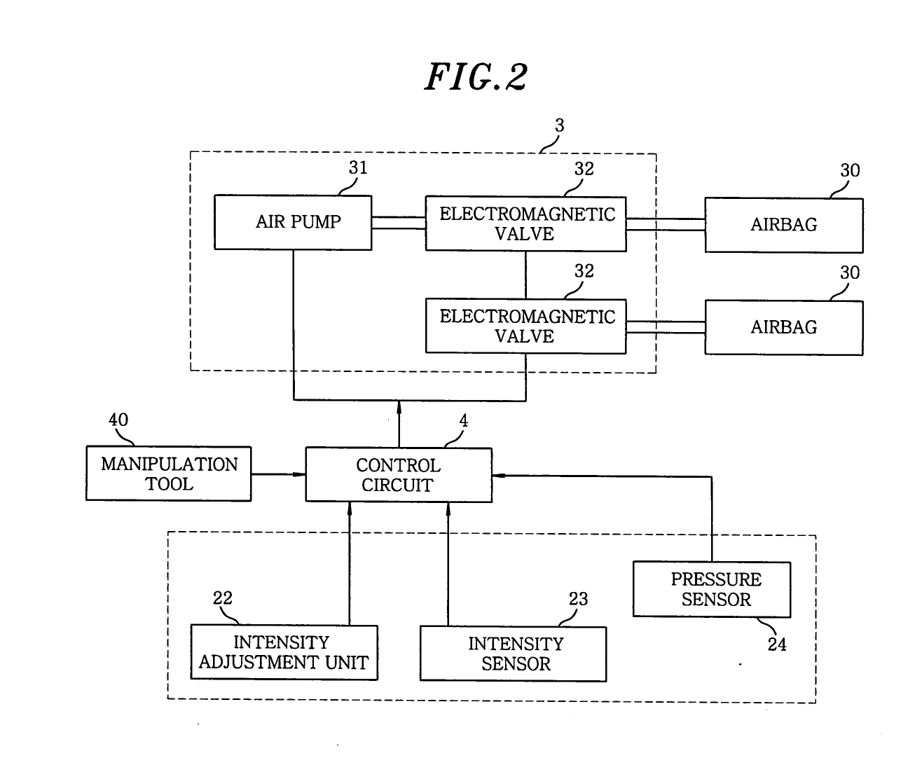

The massage mechanism 2 includes a mechanical part for causing the massage members 21 to make massaging movement and a first intensity adjustment unit 22 (see FIG. 2) for adjusting the massage intensity of the massage members 21 by changing the position of the massage members 21 in a back-and-forth direction of the backrest 11 (as indicated by arrows in FIG. 1).

The mechanical part, the first intensity adjustment unit 22 and the self-propelled mechanism for inducing the vertical movement may be of any configuration and description thereof will be omitted herein. As an example, it may be possible to use those disclosed in Japanese Patent Laid-open Publication No. 2006-34635. The first intensity adjustment unit 22 may be of a structure in which the position of the massage members 21 is changed by moving the whole part of the massage mechanism 2 forwards and backwards. In this case, it becomes easy to further increase the extent of intensity adjustment.

The backrest 11 is opened in its crosswise central portion to provide a space in which the massage members 21 are operated. Airbags 30 and 30 extending in the vertical direction are arranged left and right in front of the backrest 11. As shown in FIG. 2, the airbags 30 are connected to an air pump 31 through electromagnetic valves 32. Through an expansion and contraction operation, the airbags 30 are designed to change the pressure at which the massage members 21 make contact with a back of a user. This is performed by moving the position of the back of the user reclining on the backrest 11 in the back-and-forth direction as indicated by the arrows in FIG. 1 and eventually changing the distance between the massage members 21 and the back of the user. The airbags 30, the air pump 31 and the electromagnetic valves 32 constitute a second intensity adjustment unit 3.

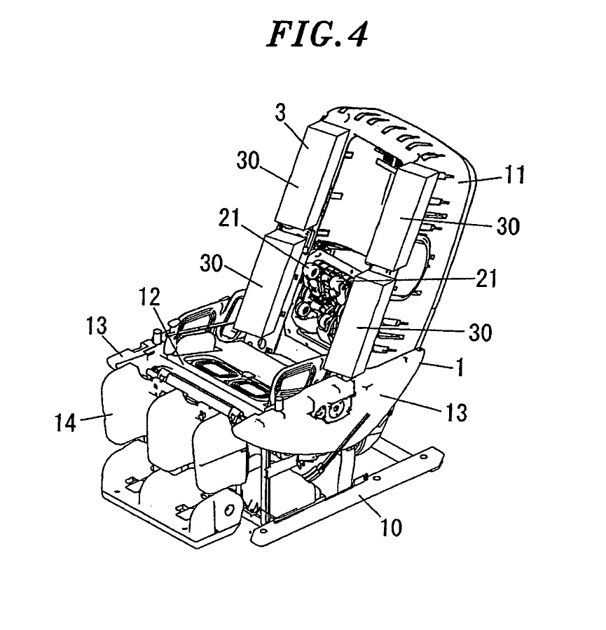

As shown in FIG. 4, the airbags 30 may include a plurality of airbags arranged vertically. In this case, only the shoulder or the waist of the user can be lifted up by expanding the corresponding airbags 30. This makes it possible to adjust the massage intensity for a particular massage region of the user, thereby realizing various kinds of massages.

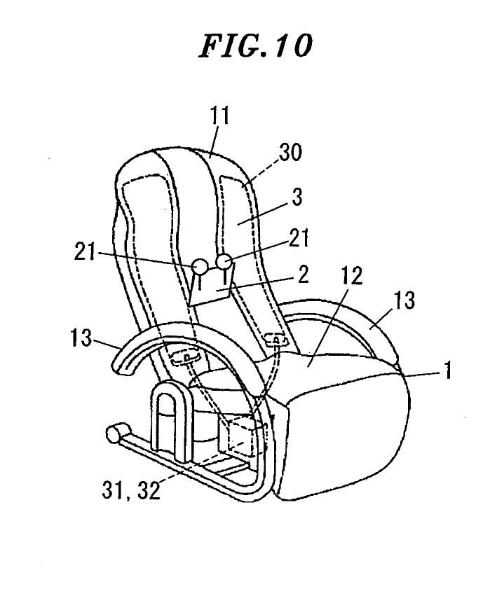

The second intensity adjustment unit 3 is not limited to the above air-operating configuration but may be of any configuration as long as it can move the support surface supporting the back of the user in the back-and-forth direction. For example, a motor and a link mechanism may be used as the second intensity adjustment unit 3. In case of a massage machine in which the front surface (support surface) of the backrest 11 has a curved surface shape in conformity with the back of the user as shown in FIG. 10, it is equally possible to allow the airbags 30 to move in conformity with the curved surface of the backrest 11.

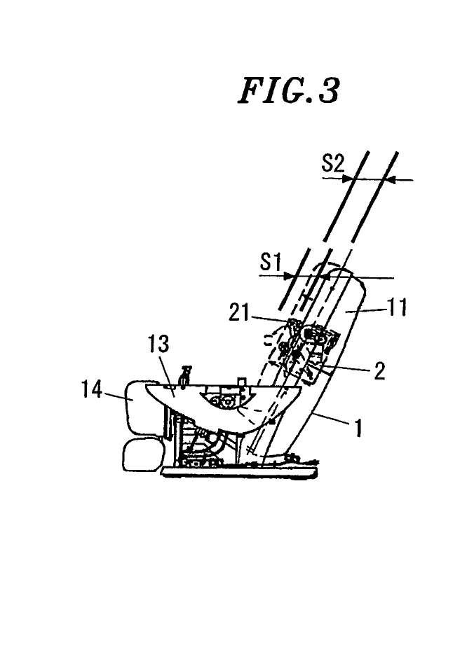

Assuming that the back-and-forth stroke of the massage members 21 moved by the first intensity adjustment unit 22 is S1 and the back-and-forth stroke of the support surface supporting the back of the user moved by the second intensity adjustment unit 3 is S2, it is preferred that the strokes S1 and S2 are overlapped with each other as illustrated in FIG. 3. It is also preferred that the overlapping is set in such a manner as to reduce the effective amount of intensity adjustment performed by the first intensity adjustment unit 22 when the airbags 30 of the second intensity adjustment unit 3 are expanded to its maximum volume (that is, when the massage intensity is set smallest).

The massage machine includes an intensity sensor 23 for detecting the position (protruding amount) of the massage members 21 set by the first intensity adjustment unit 22 and a pressure sensor 24 for detecting the pressure at which the massage members 21 make contact with the user. A manipulation tool 40 as well as the sensors 23 and 24 is connected to the control circuit 4 that controls the operation of the first and the second intensity adjustment units 22 and 3. In the course of performing the massage intensity adjustment, the control circuit 4 controls the first and the second intensity adjustment units 22 and 3 as follows.

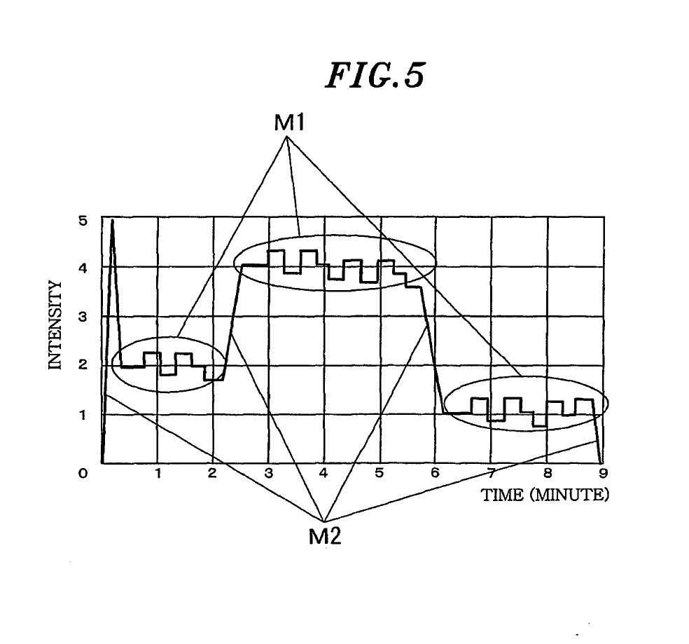

When the extent of intensity adjustment in the massage machine of the present embodiment is divided into five stages between the zero (where intensity is adjusted to its minimum) to fifth level (where intensity is adjusted to its maximum) as illustrated in FIG. 5, the transition between the five stages (designated by M2 in FIG. 5) is performed by the second intensity adjustment unit 3 but the intensity adjustment within a single stage (designated by M1 in FIG. 5) is carried out by the first intensity adjustment unit 22. Rough adjustment of the massage intensity is performed by expanding or contracting the airbags 30 and eventually moving the support surface that supports the back of the user. Fine adjustment of the massage intensity in conformity with change in shape of each part of the user's body is carried out by the first intensity adjustment unit 22 that exhibits enhanced responsiveness. The reason for this is that, if the fine intensity adjustment is performed slowly, no user becomes aware of whether the intensity adjustment is in progress or not. Another reason is that a pain is caused if the massage members 21 belatedly response to the change in shape of the each part of the user's body during the course of performing a “rolling massage” where the massage members 21 are moved along the back of the user.

In order for the first intensity adjustment unit 22 to be able to make the fine adjustment, the first intensity adjustment unit 22 is always returned back to a nearly intermediate position of the adjustment extent thereof whenever the second intensity adjustment unit 3 performs its intensity adjustment. Therefore, the first intensity adjustment unit 22 is capable of finely adjusting the massage intensity either to increase or decrease after the rough adjustment of massage intensity has been performed by the second intensity adjustment unit 3. It may be possible for the first intensity adjustment unit 22 to finely adjust the massage intensity only to decrease in the maximum intensity position and only to increase in the minimum intensity position.

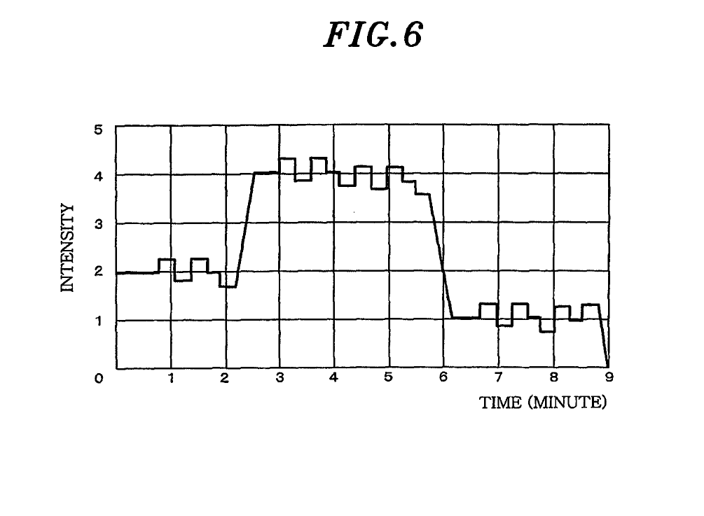

After electric power is supplied, the first massage operation may be started after the second intensity adjustment unit 3 has been set at a predetermined (or user-selected) massage intensity as illustrated in FIG. 6. As the pressure detected by the pressure sensor 24 fluctuates within a specified extent, the control circuit 4 performs feed-back control of the massage intensity through the first intensity adjustment unit 22.

When the detected pressure is greatly changed or when a command for changing massage intensity is inputted through the manipulation tool 40, the rough adjustment of intensity is performed by the second intensity adjustment unit 3 and subsequently the fine adjustment of intensity is carried out by the first intensity adjustment unit 22.

If the intensity adjustment that moves the position of the massage members 21 using the first intensity adjustment unit 22 is performed during a certain kind of massage operation, there is a possibility that the massage operation may be adversely affected and the massage force greater than that required may be exerted on the user's body. However, the intensity adjustment using the second intensity adjustment unit 3 is free from such possibility. Therefore, it is possible to suitably perform the intensity adjustment by allowing the first intensity adjustment unit 22 with enhanced responsiveness to make the fine adjustment of intensity but allowing the second intensity adjustment unit 3, which applies no load to the user, to carry out the rough adjustment of intensity.

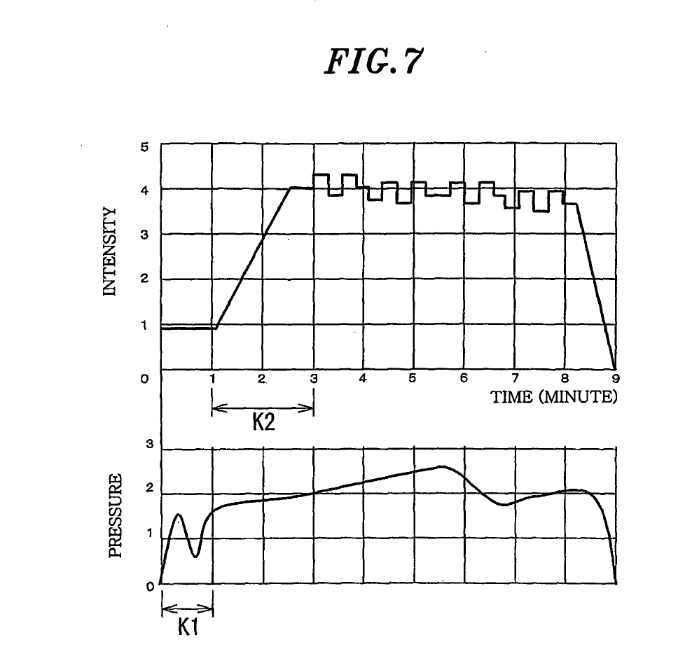

FIG. 7 shows an example of the response to the change in the output of the pressure sensor 24 at the time when a spine stretching (rolling) massage is performed by vertically moving the massage members 21 along the back of the user. Section K1 designates a section in which the shape of the back of the user is detected by vertically moving the massage members 21 while keeping constant the protruding amount (intensity position) of the massage members 21. Section K2 designates a section in which the massage intensity for a spine stretching massage is set. The remainder is a section in which the massage intensity is feedback controlled according to the output of the pressure sensor 24.

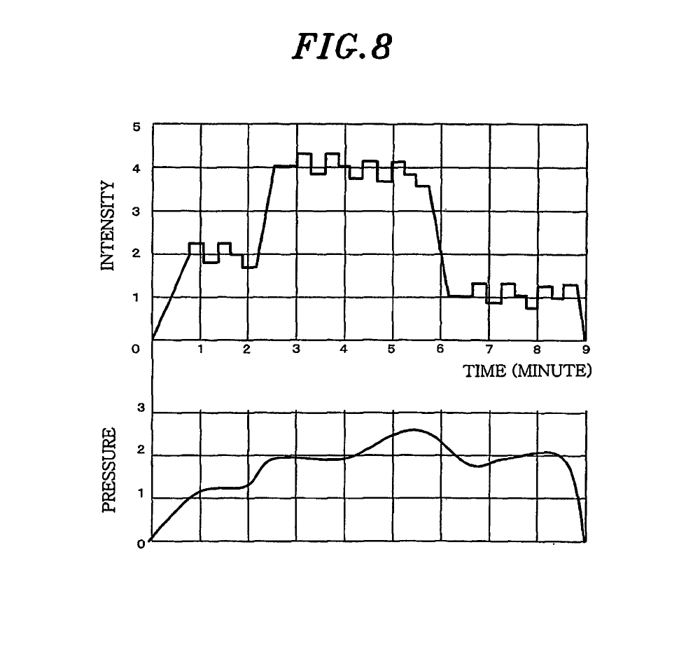

FIG. 8 shows a feedback control operation according to the pressure detected by the pressure sensor 24 at the time when the contact pressure between the massage members 21 and the user's body is set at a predetermined value (2 in FIG. 8). If the contact pressure has not yet reached the predetermined value or if the contact pressure is far greater than the predetermined value, the massage intensity is adjusted by the second intensity adjustment unit 3. If the contact pressure stays near the predetermined value, the massage intensity is adjusted by the first intensity adjustment unit 22.

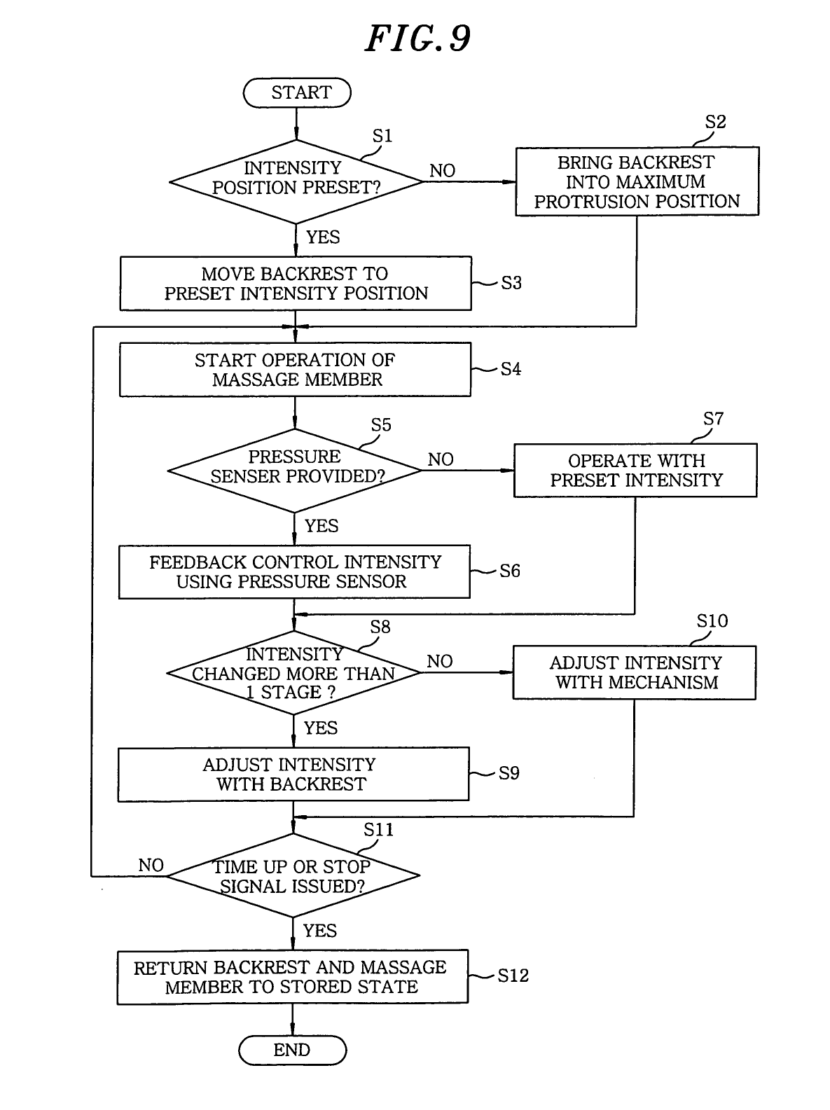

FIG. 9 is a flowchart illustrating the massaging operation conducted by the massage machine.

First, in response to an input manipulation to start massaging from the user, the control circuit 4 determines whether a specific intensity position is set or not in step S1. If it is determined that a specific intensity position is set, the support surface of the backrest 11 is moved to the specific intensity position (step S3). If not, the support surface of the backrest 11 is brought into a maximum protrusion position, that is, the airbags 30 is expanded to its maximum volume (step S2).

After performing step S2 or S3, the massage members 21 make contact with the back of the user to start massaging operation (step S4). When starting the operation of the massage members 21, it is determined whether the pressure sensor 24 is provided or not in step S5. A pressure is detected if it is determined that the pressure sensor 24 is provided. According to the fluctuation of the pressure, the control circuit 4 performs feed-back control of the massage intensity through the first intensity adjustment unit 22 (step S6). If it is determined that the pressure sensor 24 is not provided, the massage members 21 are operated with a preset massage intensity (step S7).

After performing the step S6 or S7, the control circuit 4 determines whether the massage intensity is changed more than 1 stage or not in step S8. If it is determined that the massage intensity is changed more than 1 stage, the massage intensity is roughly adjusted through the second intensity adjustment unit 3 (step S9). If not, the massage intensity is finely adjusted through the first intensity adjustment unit 22 (step S10).

After performing step S9 or S10, it is determined whether or not a preset massaging time period has elapsed or a stop signal issued by the user through the manipulation tool in step S11. If not, the loop of steps S4 to S10 is repeated. Otherwise, the backrest 11 and the massage members 21 are returned to their initial positions (step S12) and the massaging operation is terminated.

While the invention has been shown and described with respect to the embodiments, it will be understood by those skilled in the art that various changes and modifications may be made without departing from the scope of the invention as defined in the following claims.

What is claimed is:

1. A massage machine comprising:
a backrest having a support surface for sustaining a back of a user, the support surface having an opening;
a massage member for making contact with the back of the user through the opening of the support surface to perform a massage;
a drive unit for causing the massage member to perform the massage;
a first intensity adjustment unit for changing the position of the massage member to adjust the massage intensity of the massage member;
a second intensity adjustment unit for changing the position of the support surface to adjust the massage intensity of the massage member; and
a control circuit for controlling the operation of the drive unit, the first intensity adjustment unit and the second intensity adjustment unit.

2. The massage machine of claim 1, wherein the control circuit allows the second intensity adjustment unit to make rough intensity adjustment and allows the first intensity adjustment unit to make fine intensity adjustment.

3. The massage machine of claim 2, wherein the control circuit causes the massage member to start the massage in a predetermined intensity position set by the second intensity adjustment unit.

4. The massage machine of claim 3, wherein the predetermined intensity position is a position set by an input manipulation of a user.

5. The massage machine of claim 1, further comprising a pressure sensor for detecting a contact pressure between the massage member and the back of the user, and wherein the control circuit recognizes the shape of the back of the user from the change in output of the pressure sensor at the time when the massage member is moved along the back of the user and initially sets the massage intensity based on the results of recognition.

6. The massage machine of claim 5, wherein the control circuit adjusts the massage intensity according to the change in output of the pressure sensor even after the massage intensity has been initially set.

7. The massage machine of claim 1, wherein the second intensity adjustment unit comprises an airbag arranged on the support surface for expansion and contraction.

8. The massage machine of claim 7, wherein the airbag includes a plurality of airbags arranged in a vertical direction along the back of the user.
